(19) United States
(12) Patent Application Publication
(10) Pub. No.: US 2026/0343127 A1
(43) Pub. Date: Oct. 29, 2026

(54) SLEEP SPEAKER WITH WIRELESS CHARGING FUNCTION

(71) Applicant: Shenzhen DreamCove Tech Co.,Ltd, Shenzhen (CN)

(72) Inventor: Jianping Wang, Shenzhen (CN)

(21) Appl. No.: 19/707,261

(22) Filed: Jun. 13, 2026

(30) Foreign Application Priority Data
May 19, 2026 (CN) 202620705632.6

(51) Int. Cl. H04R 1/02; F21V 23/04; F21V 33/00; F21Y 103/10; F21Y 103/33; F21Y 115/10; H02J 7/70; H02J 50/00; H02J 50/10

(52) U.S. Cl. CPC H04R 1/028; F21V 23/0435; F21V 33/0056; H02J 7/70; H02J 50/005; H02J 50/10; H04R 1/023; H04R 1/026; F21V 2200/00; F21Y 2103/10; F21Y 2103/33; F21Y 2115/10

(57) ABSTRACT

Provided is a sleep speaker with a wireless charging function, which belongs to the technical field of speakers. The sleep speaker with a wireless charging function includes a speaker middle housing, a convex upper housing, side housings, and a lower housing. The convex upper housing is mounted on a top of the speaker middle housing. The side housings are symmetrically mounted on both sides of the speaker middle housing. A wireless charging base is disposed on a top surface of the convex upper housing. A charging coil is mounted inside the wireless charging base. In the present disclosure, a convex structure design of the convex upper housing cooperates with the wireless charging base on the top surface and the internal charging coil, and the sleep speaker can adapt to a mobile phone with a protruding camera.

### TECHNICAL FIELD

The present disclosure relates to the technical field of speakers, and in particular to a sleep speaker with a wireless charging function.

### BACKGROUND

With popularization of a smart home, a sleep speaker is used as an auxiliary device for improving sleep quality, and the sleep speaker is being applied in increasingly extensive scenarios. Most existing sleep speakers only have basic audio playback and alarm clock functions, and are single in function and insufficient in practicability. It is difficult to meet diversified use requirements of a user. In a bedside use scenario, the user often needs to charge a mobile phone at the same time. However, a conventional sleep speaker is not integrated with a wireless charging structure, and a charger and a data cable need to be disposed in addition. This not only occupies desktop space but also causes messy wiring and spoils tidiness of home environment. In addition, top surfaces of most speakers are designed in planes, and cannot be adapted to a mobile phone with a protruding camera. As a result, when being placed, the mobile phone is prone to tilting and warping, and is low in attachment degree, which severely affects stability and charging efficiency of wireless charging.

In addition, interactive experience of the existing sleep speakers needs to be improved. Generally, most atmosphere lamps are single in color or are in a fixed mode, lack dynamic switching and breathing lamp effects, and it is difficult to create a comfortable bedtime atmosphere. A display module with limited function can only display basic information such as time and power, and cannot be in linkage with an intelligent terminal to display customized patterns, texts or song names. Therefore, there is still considerable room for improvement in the overall user experience.

### SUMMARY

Embodiments of the present disclosure provide a sleep speaker with a wireless charging function, and aim to solve problems of single function, poor wireless charging adaptability, simple atmosphere display effect and insufficient use stability of existing sleep speakers.

To achieve the foregoing objective, the present disclosure provides a sleep speaker with a wireless charging function, including a speaker middle housing, a convex upper housing, side housings, and a lower housing, where the convex upper housing is mounted on a top of the speaker middle housing, the side housings are symmetrically mounted on both sides of the speaker middle housing, sound output grid holes are provided on a surface of the side housing, and the lower housing is mounted at a bottom of the speaker middle housing;
a wireless charging base is disposed on a top surface of the convex upper housing, a charging coil is mounted inside the wireless charging base, a light guide inner ring is disposed on an inner edge of the convex upper housing, and a digital tube module is disposed inside the convex upper housing; and
a button assembly is disposed on a side surface of the speaker middle housing, an atmosphere lamp mechanism that directly faces the light guide inner ring is mounted on a top of the speaker middle housing, and a main control circuit board, a lithium battery, and loudspeaker units are further mounted inside the speaker middle housing.

As a preferred embodiment of the present disclosure, the button assembly includes a power button, an atmosphere lamp button, an upper switch button, a SNOOZE button, a lower switch button, a DB (Day Button) button, and an alarm clock button that are mounted on the side surface of the speaker middle housing, and the power button, the atmosphere lamp button, the upper switch button, the SNOOZE button, the lower switch button, the DB button, and the alarm clock button are electrically connected to the main control circuit board.

As a preferred embodiment of the present disclosure, the digital tube module includes an LED (Light Emitting Diode) board and a digital tube control panel that are fixedly mounted inside the convex upper housing, the digital tube control panel is electrically connected to the main control circuit board, the LED board is electrically connected to the digital tube control panel, the main control circuit board is integrated with a Bluetooth module, and the digital tube module is wirelessly connected to an intelligent terminal by using the Bluetooth module.

As a preferred embodiment of the present disclosure, the atmosphere lamp mechanism includes an annular cavity provided on the top of the speaker middle housing, an annular LED lamp strip is mounted inside the annular cavity, a light guide cover covers an outside of the annular cavity, the light guide cover is fastened and connected inside the annular cavity, the annular LED lamp strip is electrically connected to the main control circuit board, and the light guide cover is disposed corresponding to the light guide inner ring.

As a preferred embodiment of the present disclosure, a plurality of upper housing fixing studs are fixedly disposed inside the convex upper housing, and the upper housing fixing studs are fixedly connected to the speaker middle housing by using screws.

As a preferred embodiment of the present disclosure, a plurality of non-slip mats are mounted at a bottom of the lower housing.

As a preferred embodiment of the present disclosure, a charging control panel is electrically connected to the main control circuit board, the charging control panel is fixedly connected to an inner side of the speaker middle housing, the charging control panel is integrated with a DC (Direct Current) charging base exposed outside the speaker middle housing, and the DC charging base is electrically connected to the lithium battery by using the charging control panel.

As a preferred embodiment of the present disclosure, the loudspeaker units are fixedly mounted inside both sides of the speaker middle housing, a sound output end of the loudspeaker unit is disposed in direct alignment with the sound output grid holes, and the loudspeaker unit is electrically connected to the main control circuit board.

Compared with the prior art, the present disclosure has the following beneficial effects.

First, in the present disclosure, a convex structure design of the convex upper housing cooperates with the wireless charging base on the top surface and the internal charging coil, and the sleep speaker can adapt to a mobile phone with a protruding camera, so as to ensure that the mobile phone is stably attached to a charging area and improve stability and adaptability of wireless charging. In addition, the main control circuit board is integrated with the Bluetooth module, so as to implement wireless connection to an intelligent terminal. The sleep speaker may wirelessly play sleep-aiding audios, and may also display customized patterns, texts and song names by using the digital tube module, thereby enriching interactive experience. The atmosphere lamp mechanism may implement multi-color switching and breathing lamp effects by using cooperation among the annular LED lamp strip, the light guide cover, and the light guide inner ring, thereby creating a comfortable bedtime atmosphere.

Second, in the present disclosure, the speaker middle housing, the convex upper housing, the side housings, and the lower housing are assembled to form a stable overall structure, and the convex upper housing is fixed by using the upper housing fixing studs and the speaker middle housing through screws, and a connection is firm and not prone to loosening. The non-slip mats at the bottom of the lower housing increase friction force with a placement surface, so as to avoid speaker displacement caused by desktop vibration. The button assembly has set functions of a power supply, the atmosphere lamp, track switching, snooze, and an alarm clock. The sleep speaker is convenient in operation, and meets use requirements in a sleep scenario. Wireless charging, audio playback, atmosphere lighting, and digital display functions are integrated as a whole, and the practicability is high, so that user satisfaction of the speaker is improved.

### BRIEF DESCRIPTION OF THE DRAWINGS

FIG. 1 is an integral structure diagram according to the present disclosure;

FIG. 2 is one of integral structure diagrams according to the present disclosure;

FIG. 3 is a split diagram according to the present disclosure;

FIG. 4 is an internal structure diagram of a convex upper housing according to the present disclosure;

FIG. 5 is one of split diagrams according to the present disclosure; and

FIG. 6 is an internal structure diagram of a speaker middle housing according to the present disclosure.

Reference numerals in the drawings: 100: speaker middle housing; 110: convex upper housing; 111: wireless charging base; 112: charging coil; 113: light guide inner ring; 120: button assembly; 121: power button; 122: atmosphere lamp button; 123: upper switch button; 124: SNOOZE button; 125: lower switch button; 126: DB button; 127: alarm clock button; 130: digital tube module; 131: LED board; 132: digital tube control panel; 140: upper housing fixing stud; 200: side housing; 210: sound output grid hole; 300: lower housing; 310: non-slip mat; 400: atmosphere lamp mechanism; 410: annular cavity; 420: annular LED lamp strip; 430: light guide cover; 500: main control circuit board; 510: charging control panel; 520: DC charging base; 600: lithium battery; and 700: loudspeaker unit.

### DETAILED DESCRIPTION OF THE EMBODIMENTS

The technical schemes according to embodiments of the present disclosure are clearly and completely described in the following with reference to the drawings in the present disclosure. Apparently, the embodiments in the following description are merely a part rather than all of the embodiments of the present disclosure. Based on the embodiment in the present disclosure, all other embodiments obtained by the ordinary technical staff in the art without contributing creative labor belong to the scope protected by the present disclosure.

### Embodiments

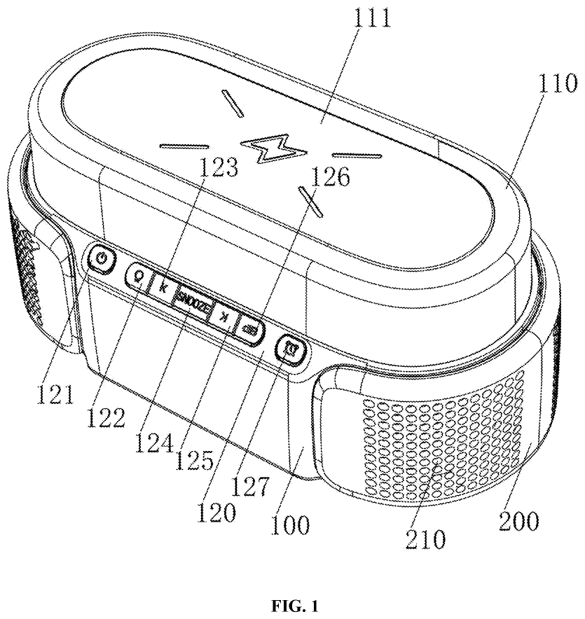

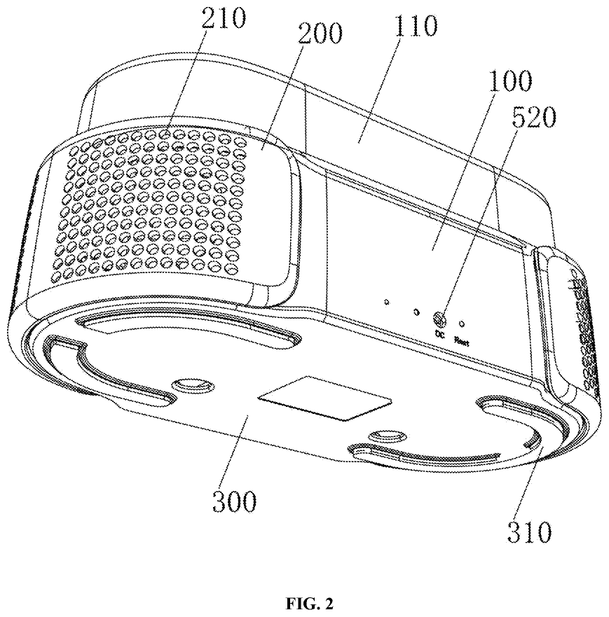

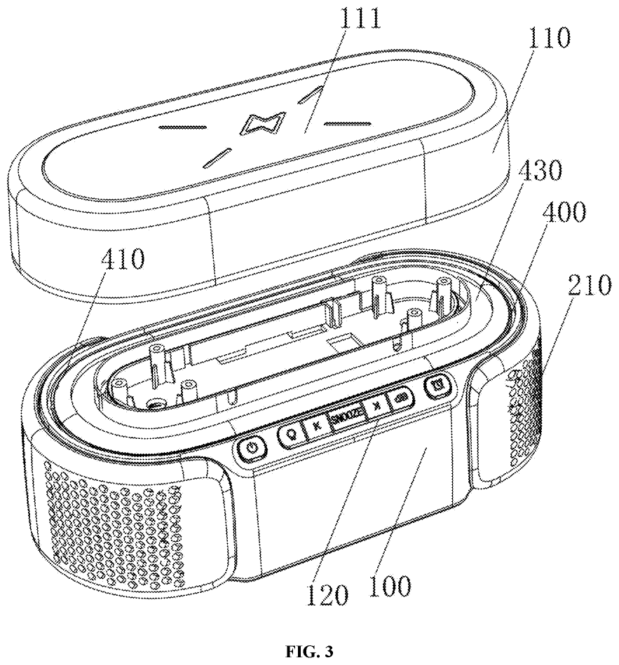

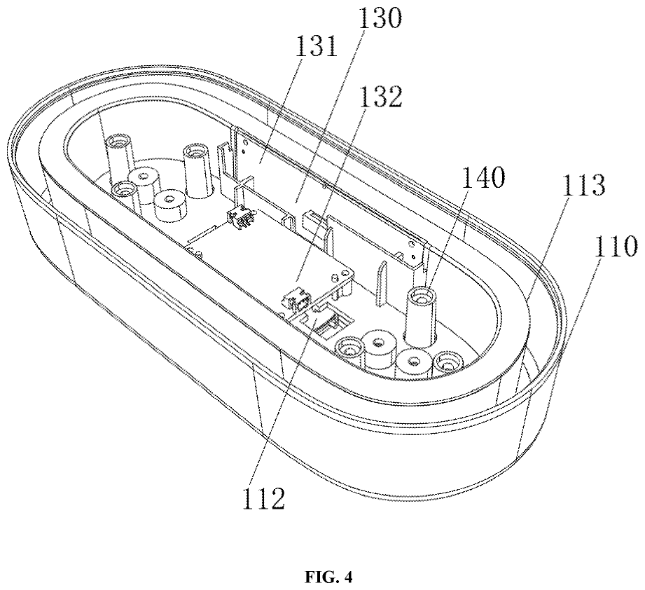

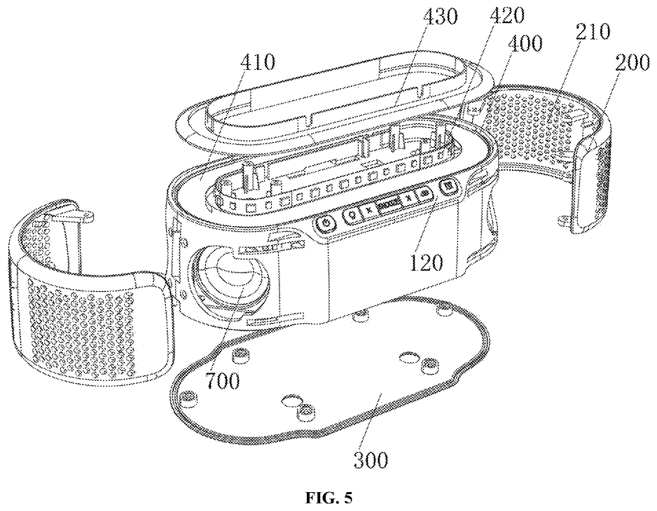

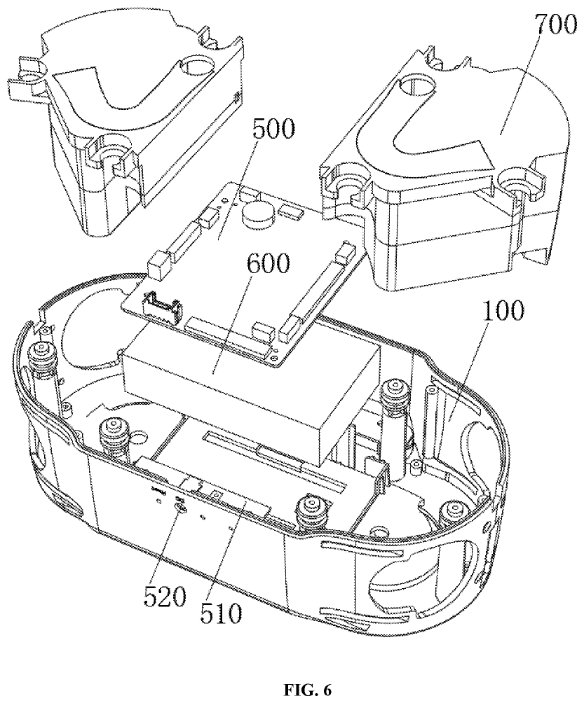

Referring to FIG. 1 to FIG. 6, the present disclosure provides a sleep speaker with a wireless charging function, including a speaker middle housing 100, a convex upper housing 110, side housings 200, and a lower housing 300, where the convex upper housing 110 is mounted on a top of the speaker middle housing 100, the side housings 200 are symmetrically mounted on both sides of the speaker middle housing 100, sound output grid holes 210 are provided on a surface of the side housing 200, and the lower housing 300 is mounted at a bottom of the speaker middle housing 100;
a wireless charging base 111 is disposed on a top surface of the convex upper housing 110, a charging coil 112 is mounted inside the wireless charging base 111, a light guide inner ring 113 is disposed on an inner edge of the convex upper housing 110, and a digital tube module 130 is disposed inside the convex upper housing 110; and
a button assembly 120 is disposed on a side surface of the speaker middle housing 100, an atmosphere lamp mechanism 400 that directly faces the light guide inner ring 113 is mounted on a top of the speaker middle housing 100, and a main control circuit board 500, a lithium battery 600, and loudspeaker units 700 are further mounted inside the speaker middle housing 100.

Specifically, when the sleep speaker is used, a user may directly place a mobile phone on the wireless charging base 111 on the top surface of the convex upper housing 110. A convex structure of the convex upper housing 110 can provide clearance for a protruding camera of the mobile phone, so as to ensure that a bottom surface of the mobile phone is stably attached to the wireless charging base 111, and the internal charging coil 112 is electrically connected to the main control circuit board 500, thereby implementing stable wireless charging.

The user may enable an audio playback function by using the button assembly 120. The main control circuit board 500 controls the loudspeaker unit 700 to work. Sound is propagated outward through the sound output grid holes 210 of the side housing 200, and provides soft sleep-aiding audios. Light emitted by the atmosphere lamp mechanism 400 is scattered through the light guide cover 430 and the light guide inner ring 113, to form soft atmosphere lighting. The digital tube module 130 can display information such as time and song names. The speaker can adapt to a sleep scenario requirement omnidirectionally by integrating wireless charging, audio playback, atmosphere lighting, and digital display functions.

In this embodiment, the button assembly 120 includes a power button 121, an atmosphere lamp button 122, an upper switch button 123, a SNOOZE button 124, a lower switch button 125, a DB button 126, and an alarm clock button 127 that are mounted on the side surface of the speaker middle housing 100, and the power button 121, the atmosphere lamp button 122, the upper switch button 123, the SNOOZE button 124, the lower switch button 125, the DB button 126, and the alarm clock button 127 are electrically connected to the main control circuit board 500.

Specifically, the user can control the speaker to be switched on and off by using the power button 121. The light emitting color, brightness, and breathing mode of the annular LED lamp strip 420 can be switched by pressing the atmosphere lamp button 122, which is adapted to different bedtime atmosphere requirements. The upper switch button 123 and the lower switch button 125 can implement volume adjustment or switching of audio tracks. The SNOOZE button 124 is configured to trigger an alarm clock snooze function to delay time of an alarm clock that sounds again, so as to meet a requirement of staying in bed for the user. The DB button 126 can switch a sound effect mode of the speaker, and is adapted to different types of sleep-aiding audios. The alarm clock button 127 is configured to set, enable, or disable an alarm clock function. All buttons are directly electrically connected to the main control circuit board 500. The operation responds quickly, and the layout is centralized and easy to recognize, so as to facilitate a blind operation in a night sleep scenario.

In this embodiment, the digital tube module 130 includes an LED board 131 and a digital tube control panel 132 that are fixedly mounted inside the convex upper housing 110, the digital tube control panel 132 is electrically connected to the main control circuit board 500, the LED board 131 is electrically connected to the digital tube control panel 132, the main control circuit board 500 is integrated with a Bluetooth module, and the digital tube module 130 is wirelessly connected to an intelligent terminal by using the Bluetooth module.

Specifically, the user can pair and connect the intelligent terminal such as the mobile phone with the Bluetooth module of the main control circuit board 500, so as to implement audio wireless transmission and play. In addition, the user may send a control instruction by using a terminal APP, and drive the LED board 131 by using the digital tube control panel 132, so as to display information about customized patterns, texts or a name of a current playing song, thereby improving interactivity and fun of the speaker. The sleep speaker is more compatible with a use requirement of a young user.

In this embodiment, the atmosphere lamp mechanism 400 includes an annular cavity 410 provided on the top of the speaker middle housing 100, an annular LED lamp strip 420 is mounted inside the annular cavity 410, a light guide cover 430 covers an outside of the annular cavity 410, the light guide cover 430 is fastened and connected inside the annular cavity 410, the annular LED lamp strip 420 is electrically connected to the main control circuit board 500, and the light guide cover 430 is disposed corresponding to the light guide inner ring 113.

Specifically, the annular LED lamp strip 420 is mounted in the annular cavity 410 on the top of the speaker middle housing 100. The annular cavity 410 provides stable mounting space for the lamp strip. The light guide cover 430 is fixed in a fastening manner, and protects the annular LED lamp strip 420 from being damaged by dust and collision, and light can be evenly scattered. After light is scattered through the light guide cover 430, light is propagated to the outside by using the light guide inner ring 113, to form soft annular atmosphere light, so as to avoid strong light stimulation from affecting sleep. The annular LED lamp strip 420 implements multi-color switching, brightness adjustment, and breathing lamp effects by using the main control circuit board 500, and can create a comfortable bedtime environment for the user.

In this embodiment, a plurality of upper housing fixing studs 140 are fixedly disposed inside the convex upper housing 110, and the upper housing fixing studs 140 are fixedly connected to the speaker middle housing 100 by using screws.

Specifically, the convex upper housing 110 is fixed to the speaker middle housing 100 by using the plurality of upper housing fixing studs 140 with screws, so that connection is firm and disassembly is convenient, and later maintenance and maintenance is facilitated. The plurality of upper housing fixing studs 140 are evenly distributed, so that a joint between the convex upper housing 110 and the speaker middle housing 100 is uniformly stressed to avoid problems such as loosening and a gap becoming large after long-term use, thereby improving stability of an overall structure and prolonging a service life of the overall structure.

In this embodiment, a plurality of non-slip mats 310 are mounted at a bottom of the lower housing 300.

Specifically, the plurality of non-slip mats 310 at the bottom of the lower housing 300 are made of a wear-resistant and non-slip rubber material, and are evenly distributed on a bottom surface of the lower housing 300, thereby increasing friction force between the speaker and a placement surface, and effectively preventing speaker displacement caused by desktop vibration or accidental touch.

In this embodiment, a charging control panel 510 is electrically connected to the main control circuit board 500, the charging control panel 510 is fixedly connected to an inner side of the speaker middle housing 100, the charging control panel 510 is integrated with a DC charging base 520 exposed outside the speaker middle housing 100, and the DC charging base 520 is electrically connected to the lithium battery 600 by using the charging control panel 510.

Specifically, when electric energy of the lithium battery 600 is insufficient, the user may connect to an external power supply by using the DC charging base 520, to charge the lithium battery 600 by using the charging control panel 510. The charging control panel 510 can intelligently control charging current and voltage, so as to ensure safe and stable charging. The DC charging base 520 is exposed outside the speaker middle housing 100, so that it is easy to plug and unplug a charging cable. The lithium battery 600 is fully charged and then provides lasting life for the speaker, so that the speaker can be used independently from a power cable and can be placed without being limited by a socket position, and bedside placement is more flexible.

In this embodiment, the loudspeaker units 700 are fixedly mounted inside both sides of the speaker middle housing 100, a sound output end of the loudspeaker unit 700 is disposed in direct alignment with the sound output grid holes 210, and the loudspeaker unit 700 is electrically connected to the main control circuit board 500.

Specifically, the loudspeaker units 700 are symmetrically mounted inside both sides of the speaker middle housing 100, and the sound output end is accurately aligned with the sound output grid holes 210 of the side housing 200, so as to ensure that sound can be smoothly and uniformly propagated outward, thereby improving stereo sense and clarity of audio playback.

The loudspeaker unit 700 is electrically connected to the main control circuit board 500. Parameters such as volume and sound effect may be adjusted by the main control circuit board 500 to adapt to a play requirement of the sleep-aiding audios, so as to provide the user with a soft and comfortable auditory experience.

It needs to be noted that in this specification, relational terms such as “first” and “second” are only used to distinguish one entity or operation from another, and do not necessarily require or imply that any actual relationship or sequence exists between these entities or operations. Moreover, the terms “include”, “contain”, or any other variants are intended to cover a non-exclusive inclusion, so that a process, a method, an article, or a device that includes a list of elements not only includes those elements but also includes other elements that are not expressly listed, or further includes elements inherent to such a process, method, article, or device.

Although the embodiments of the present disclosure have already been illustrated and described, various changes, modifications, replacements and transformations can be made by those skilled in the art under the condition of without departing from the principle and the spirit of the present disclosure, and thus the scope of the present disclosure should be restricted by claims and equivalents thereof.

What is claimed is:

1. A sleep speaker with a wireless charging function, comprising a speaker middle housing (100), a convex upper housing (110), side housings (200), and a lower housing (300), wherein the convex upper housing (110) is mounted on a top of the speaker middle housing (100), the side housings (200) are symmetrically mounted on both sides of the speaker middle housing (100), sound output grid holes (210) are provided on a surface of the side housing (200), and the lower housing (300) is mounted at a bottom of the speaker middle housing (100);
a wireless charging base (111) is disposed on a top surface of the convex upper housing (110), a charging coil (112) is mounted inside the wireless charging base (111), a light guide inner ring (113) is disposed on an inner edge of the convex upper housing (110), and a digital tube module (130) is disposed inside the convex upper housing (110); and
a button assembly (120) is disposed on a side surface of the speaker middle housing (100), an atmosphere lamp mechanism (400) that directly faces the light guide inner ring (113) is mounted on a top of the speaker middle housing (100), and a main control circuit board (500), a lithium battery (600), and loudspeaker units (700) are further mounted inside the speaker middle housing (100).

2. The sleep speaker with a wireless charging function according to claim 1, wherein the button assembly (120) comprises a power button (121), an atmosphere lamp button (122), an upper switch button (123), a SNOOZE button (124), a lower switch button (125), a DB (Day Button) button (126), and an alarm clock button (127) that are mounted on the side surface of the speaker middle housing (100), and the power button (121), the atmosphere lamp button (122), the upper switch button (123), the SNOOZE button (124), the lower switch button (125), the DB button (126), and the alarm clock button (127) are electrically connected to the main control circuit board (500).

3. The sleep speaker with a wireless charging function according to claim 1, wherein the digital tube module (130) comprises an LED (Light Emitting Diode) board (131) and a digital tube control panel (132) that are fixedly mounted inside the convex upper housing (110), the digital tube control panel (132) is electrically connected to the main control circuit board (500), the LED board (131) is electrically connected to the digital tube control panel (132), the main control circuit board (500) is integrated with a Bluetooth module, and the digital tube module (130) is wirelessly connected to an intelligent terminal by using the Bluetooth module.

4. The sleep speaker with a wireless charging function according to claim 1, wherein the atmosphere lamp mechanism (400) comprises an annular cavity (410) provided on the top of the speaker middle housing (100), an annular LED lamp strip (420) is mounted inside the annular cavity (410), a light guide cover (430) covers an outside of the annular cavity (410), the light guide cover (430) is fastened and connected inside the annular cavity (410), the annular LED lamp strip (420) is electrically connected to the main control circuit board (500), and the light guide cover (430) is disposed corresponding to the light guide inner ring (113).

5. The sleep speaker with a wireless charging function according to claim 1, wherein a plurality of upper housing fixing studs (140) are fixedly disposed inside the convex upper housing (110), and the upper housing fixing studs (140) are fixedly connected to the speaker middle housing (100) by using screws.

6. The sleep speaker with a wireless charging function according to claim 1, wherein a plurality of non-slip mats (310) are mounted at a bottom of the lower housing (300).

7. The sleep speaker with a wireless charging function according to claim 1, wherein a charging control panel (510) is electrically connected to the main control circuit board (500), the charging control panel (510) is fixedly connected to an inner side of the speaker middle housing (100), the charging control panel (510) is integrated with a DC (Direct Current) charging base (520) exposed outside the speaker middle housing (100), and the DC charging base (520) is electrically connected to the lithium battery (600) by using the charging control panel (510).

8. The sleep speaker with a wireless charging function according to claim 1, wherein the loudspeaker units (700) are fixedly mounted inside both sides of the speaker middle housing (100), a sound output end of the loudspeaker unit (700) is disposed in direct alignment with the sound output grid holes (210), and the loudspeaker unit (700) is electrically connected to the main control circuit board (500).
